(19) United States
(12) Patent Application Publication
(10) Pub. No.: US 2020/0345580 A1
(43) Pub. Date: Nov. 5, 2020

(54) DOUBLE-WALLED BACKLIT CABINET STRUCTURE FOR HOT TUBS AND ALIKE

(71) Applicant: Thomas GALES, Labécéde Lauragais (FR)

(72) Inventor: Thomas GALES, Labécéde Lauragais (FR)

(21) Appl. No.: 16/858,303

(22) Filed: Apr. 24, 2020

(30) Foreign Application Priority Data
Apr. 30, 2019 (FR) FR1904583

(51) Int. Cl. A61H 33/00; A47K 3/02; A47K 3/00; F21V 33/00

(52) U.S. Cl. CPC A61H 33/6005; A47K 3/02; A61H 2033/0083; A47K 3/008; F21V 33/004; A61H 33/005

(57) ABSTRACT

Embodiments of the present invention relate to a backlit cabinet design (10), of the type used for a hot tub or bath tub, the cabinet structure comprising an external cabinet wall or spare backlit elements (12), an internal structural wall (16), and an air room cavity (14) arranged between the external cabinet wall or spare elements and the internal structural wall. Furthermore, the cabinet and the internal structural wall can be molded together with a shell (20) for receiving water, and a recessed bottom perimeter channel (22) extends around the bottom of the cabinet structure and allows the installation of lights (24) in the air room cavity to backlight the external cabinet wall.

### BACKGROUND OF THE INVENTION

### Field of the Invention

The present invention relates generally to the design of hot tubs and alike, such as bath tubs or Jacuzzis (hereinafter referred to universally as “hot tubs” for convenience). More specifically it relates to a double-walled backlit cabinet structure design allowing hot tubs' cabinets to be backlit and thus differentiated from existing products, while improving in a certain extent the energy efficiency of hot tubs and complying with local compliances and standards such as the California Energy Commission (CEC).

### Description of the Related Art

Any discussion of the prior art throughout the specification should in no way be considered as an admission that such prior art is widely known or forms part of common general knowledge in the field.

Hot tubs have been in use for years. Typically, hot tubs vary greatly in design depending on how they are manufactured. Hot tubs may be either thermoformed or rotomolded (also known as rotational molding). Rotomolded hot tubs can be manufactured from polyethylene resin.

During the manufacturing process of rotomolded hot tubs, the cabinet and the shell are molded together and are thus made of a single resin piece. To give a more finished look to rotomolded hot tubs; manufacturers sometimes fix additional synthetic panels around the cabinet. Even with the currently known extra cabinet features, the current product offer on the market may be considered to lack esthetic appeal. The design of rotomolded hot tubs greatly depends on the mold design and the resin color used during the rotational molding process.

Besides fixing additional synthetic panels, manufacturers sometimes also add extra sconce lights attached to the exterior of the cabinet to improve the appearance and visibility at night. The synthetic panels and sconces increase the cost of materials and labor for manufacturers, yet the appeal of rotomolded hot tubs is generally considered to remain less attractive than thermoformed hot tubs.

While such manufacturing operations and designs have been used for years and may be acceptable for certain manufacturers and consumers, the current offer of rotomolded hot tubs looks obsolete and are inadequate for manufacturers and consumers looking for innovative designs and solutions.

It would therefore be desirable to improve the esthetic appeal of hot tubs and especially rotomolded hot tubs.

### BRIEF SUMMARY OF THE INVENTION

In view of the foregoing disadvantages inherent in the known types of rotomolded hot tubs, the present invention aims to provide an optimized manufacturing process and design, by creating a double-walled cabinet structure. Advantageously, an improved esthetic is also provided.

The improved manufacturing process and design, which will be described subsequently in greater detail, nevertheless retain many of the advantages of the existing hot tubs mentioned heretofore.

To this end, embodiments of the present invention aim to provide a double-walled cabinet structure with a lighted air room cavity between an external cabinet wall and an internal cabinet structure.

Embodiments of the present invention relate to a backlit cabinet structure of a hot tub or bath tub, comprising an external cabinet wall, an internal structural wall, and an air room cavity arranged between the external cabinet wall and the internal structural wall, a shell for receiving water, and the installation of lights in the air room cavity to backlight the external cabinet wall.

According to one embodiment, a recessed bottom perimeter channel extends around the bottom of the cabinet structure and allows the installation of lights.

According to one embodiment, insulation foam backs the internal structural wall, which separates the foam from the air room cavity.

According to one embodiment, part of the internal structural wall is part of a hot tub structure, and the backlit cabinet structure further comprises a spare element fixed to the hot tub structure, the spare element comprising the external cabinet wall and the air room cavity.

According to one embodiment, wherein the external cabinet wall and the internal structural wall are molded together with the shell.

According to one embodiment, the insulation foam and the lights can vacuum seal the air room cavity to create an insulation air barrier between the outdoor ambient temperature and the water temperature.

According to one embodiment, the internal structural wall is backed by a reflective film to reflect light from the lights arranged in the air room cavity.

According to one embodiment, the external cabinet wall is comprised of resin, the resin being sufficiently translucent to let light shine through the external cabinet wall.

According to one embodiment, the area between the internal structural wall and the shell (20) is filled with insulation foam.

Embodiments of the present invention also relate to a two-piece mold for creating a double-walled cabinet structure according to embodiments of the invention, the two-piece mold comprising a bottom side mold to shape the internal structural wall, the bottom side of the shell, and the recessed bottom perimeter channel, and a top side mold to shape the external cabinet wall and the top part of the shell, which receives the water.

Embodiments of the present invention also relate to a method of fabricating a double-walled cabinet structure, of the type used for a hot tub or bath tub, comprising the steps of providing a two-piece mold according to embodiments of the invention, attaching the top side mold to the bottom side mold, pouring resin into the top side mold, and molding, by a rotational molding process, the double-walled cabinet structure.

According to one embodiment, the method further comprising the steps of demolding the cabinet structure, cutting the structure as needed, installing jets and lights, and insulating the interior of the shell with insulation foam.

According to one embodiment, the method further comprises the step of applying a reflective film on the internal structural wall.

Before describing the embodiments of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting. Other ways to backlight hot tubs cabinets will become evident to the reader through the present invention such as, but not limited to, fixing in the spare backlit elements like spare panels, spare backlit corners, spare backlit perimeter lines, and open backlit holes around the cabinet.

Other objects and advantages of the present invention will become obvious to the reader and it is intended that these objects and advantages are within the scope of the present invention.

To accomplish the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of an embodiment of the present invention.

FIG. 2 is a sectional partial front view of a two-piece mold used to manufacture a double-walled backlit cabinet structure according to one embodiment of the present invention.

FIG. 3 is a sectional front view of a double-walled cabinet structure according to one embodiment of the present invention after being unmolded.

FIG. 4 is a sectional front view of a double-walled cabinet structure according to one embodiment of the present invention after being drilled.

FIG. 5 is a sectional front view of a double-walled cabinet structure according to one embodiment of the present invention after being equipped.

FIG. 6 is a sectional front view of a double-walled cabinet structure according to one embodiment of the present invention after being foamed.

FIG. 7 is a sectional front view of a double-walled cabinet structure according to one embodiment of the present invention in use in a dark environment.

FIG. 8 is an exploded front view of a double-walled cabinet structure according to one embodiment of the present invention.

FIG. 9 is a sectional top view taken along lines 4.4 of FIG. 8 of a double-walled cabinet structure according to one embodiment of the present invention in use.

FIG. 10 is an exploded upper perspective view of a double-walled cabinet structure according to one embodiment of the present invention.

FIG. 11 is a bottom view of a double-walled cabinet structure according to one embodiment of the present invention.

FIG. 12 is an exploded sectional front view of a double-walled cabinet structure according to a second embodiment of the present invention.

### DETAILED DESCRIPTION OF THE INVENTION

### General Overview

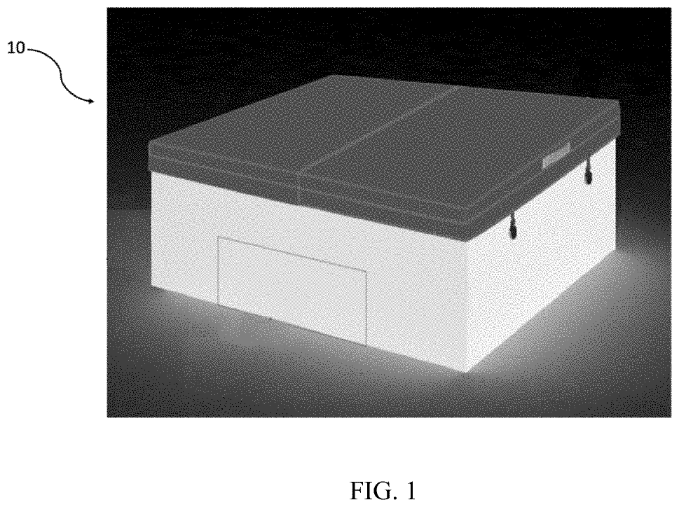

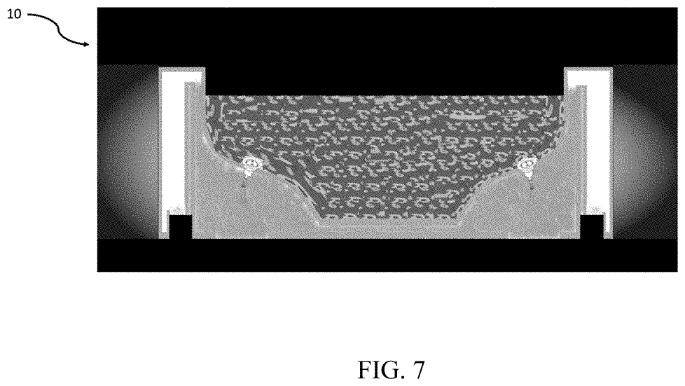

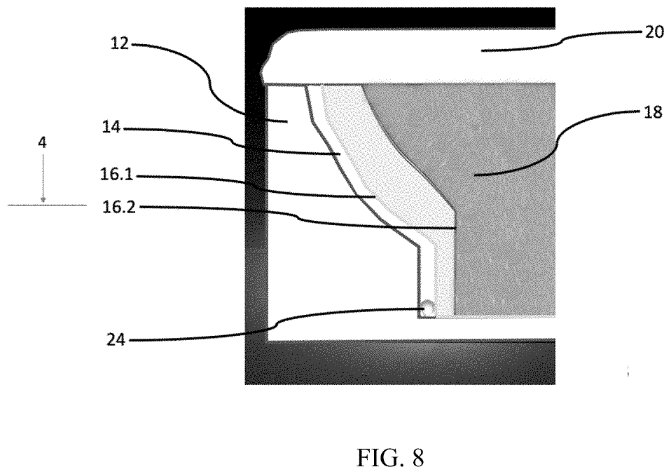

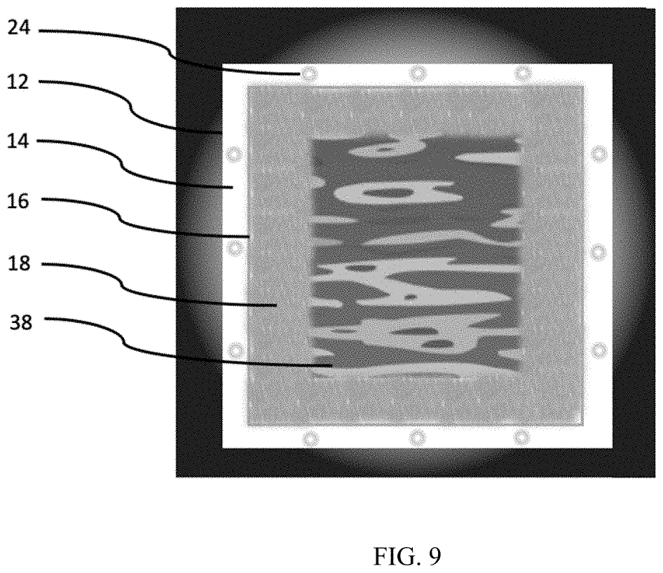

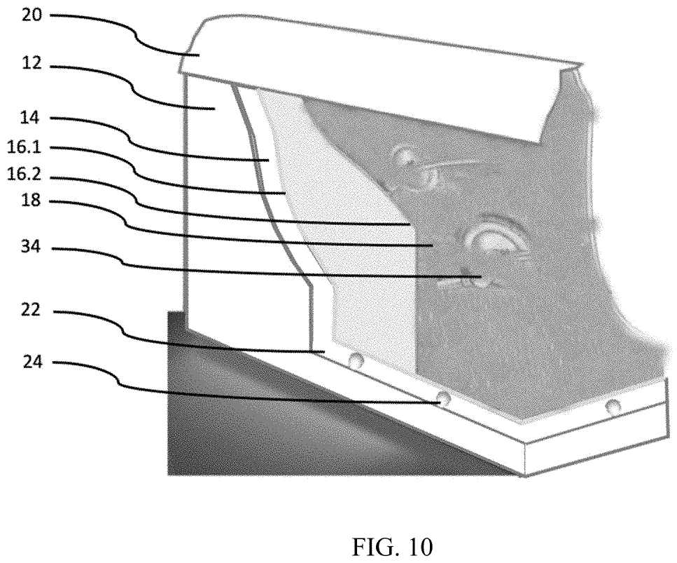

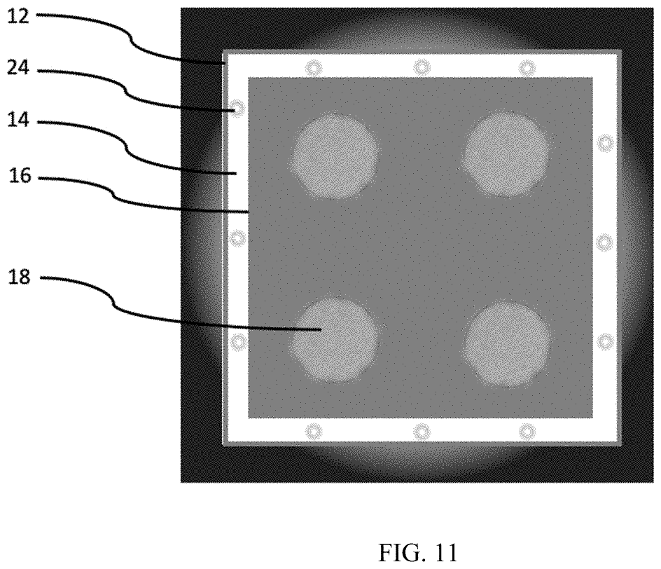

In the drawings, in which similar reference characters denote similar elements throughout the several views, FIGS. 1 to 11 illustrate a first embodiment of a double-walled backlit cabinet structure design 10 that can be lighted when in use. The backlit cabinet design comprises an external cabinet wall 12 backed with an air room cavity 14 which is in turn backed with an internal structural wall 16. That is to say, the air room cavity 14 is arranged between the external cabinet wall 12 and the internal structural wall 16. Insulation foam 18 backs the internal structural wall 16. According to this embodiment, the external backlighted cabinet wall 12 and the internal structural wall 16 are molded together with a shell 20 and a recessed bottom perimeter channel 22.

In this embodiment, the external cabinet wall 12, the internal structural wall 16, the shell 20, and the recessed bottom perimeter channel 22 can be molded together thanks to a two-piece mold comprised of a bottom side mold 26 and a top side mold 28 into which a resin 30 is poured. Various spotlights 24, which may be multicolored and/or of the LED (Light-Emitting Diode) type, are mounted on a recessed bottom perimeter channel 22 in order to light the air room cavity 14, such that the external cabinet wall 12 is backlit. The insulation foam 18 is sprayed around the shell 20 and around jets 34 and plumbing, and backs the internal structural wall 16.

### The Double-Walled Backlit Cabinet Design 10

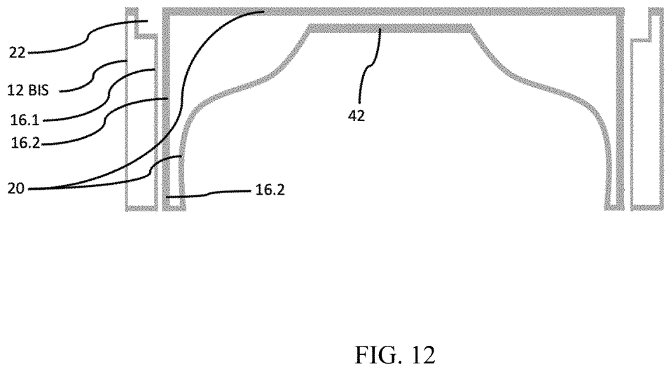

As shown in FIGS. 1 to 7, the double-walled backlit cabinet structure design 10 can be built for roto-molded hot tubs and bath tubs but can also be used for acrylic hot tubs and acrylic bath tubs. That is to say, the same concept comprising an external cabinet wall 12 and an internal structural wall 16 separated by an air room cavity 14, and comprising lights as described above can also be used for acrylic hot tubs and bath tubs. Another way to use the backlit cabinet design 10, notably on acrylic hot tubs and bath tubs consists in simply integrating spare translucent backlit elements (for example roto-molded) attached to the cabinet or directly to the shell, and surrounding (at least partially) the shell, as will be presented below in reference to FIG. 12.

### The External Cabinet Wall 12

The external cabinet wall 12 is preferably comprised of polyethylene, also known as resin 30. The resin 30 is preferably translucent enough to allow the spotlights 24 to shine through it at night and during daytime, to a lesser extent. The resin 30 is opaque enough so as to diffuse light entering the resin, so that diffused light inside the resin 30 be visible from outside the hot tub.

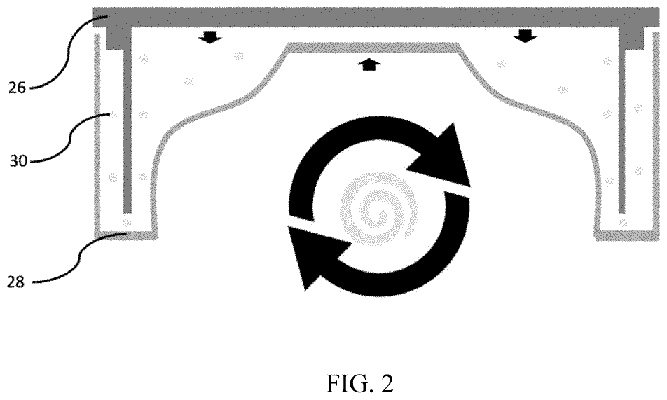

As shown in FIG. 2, according to one embodiment, the external cabinet wall 12, the internal structural wall 16, the shell 20 and the recessed bottom perimeter channel 22 are molded together thanks to the two-piece mold comprising the bottom side mold 26 and the top side mold 28 (of which only the inner face is shown on FIG. 2), into which the resin 30 is poured. During roto-molding, the resin adheres to the inner surface of the mold, leaving an empty space between the two layers of resin (one layer of resin adhered to the inner face of the top-side mold, and one layer of resin adhered to the inner face of the bottom-side mold). The resin 30 may be of distinct colors and types in order to impart a wide range of looks and textural effects to the external backlighted cabinet wall 12, such as, but not limited to, glossy, sleek, rough styles . . . . Additionally, other materials such as films or spare translucent or solid elements can be fixed or integrated to the exterior surface of the cabinet to contrast with the resin color of the cabinet.

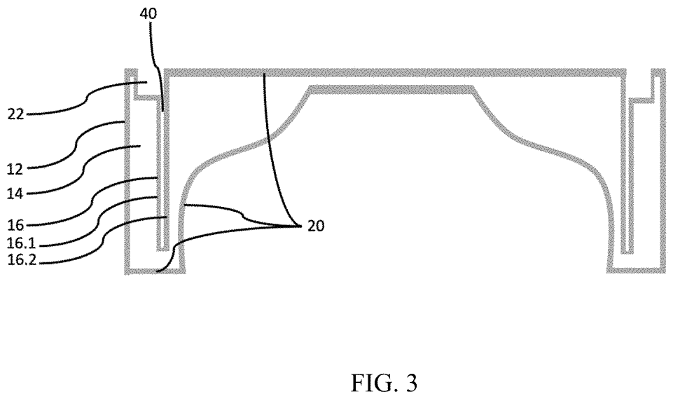

FIG. 3 shows the product after demolding, and it may be seen that the four components (the external cabinet wall 12, the internal structural wall 16, the shell 20, and the recessed bottom perimeter channel 22) are already sealed together.

Also, the top side mold 28 may be provided with non-straight external lines, permitting indeed the integration of spare elements such as stainless inserts, wood inserts or any kind of material that can contrast with the cabinet color. Such a provision of non-straight external lines also allows the embossing, shadow, transparency and potentially cut of windows on the cabinet to be adjusted as desired, thus creating three-dimensional effects permitting optional figurative or abstract designs with no additional material costs, such as trademarks, rays of sunshine and so on.

Straight and sharp external angle lines as shown in FIG. 1 are generally considered to provide a more modern and innovative appearance in comparison with existing roto-molded hot tubs with curved corners and recessed bottom cabinets. The same applies to the accessory steps or lounge bunches that should visually match with the backlit cabinet design 10.

### The Air Room Cavity 14

The air room cavity 14 is an intentional cavity created between the external cabinet wall 12 and the internal structural wall 16. The purpose of the air room cavity 14 is to permit the spotlights 24 or other type of LEDs to forcefully spread light in a reduced and closed room cavity comparable to a tunnel of light. The volume of the air room cavity 14, the luminescence and wattage of the spotlights 24, the quantity, the color and transparence of resin 30 poured in the mold have a direct impact on the luminosity of the external cabinet wall 12.

For optimal heat retention of the water and better energy efficiency, the insulation foam 18 and the spotlights 24 should vacuum seal the air room cavity 14 on its top and bottom sides. The absence of air circulation in the air room cavity 14 creates an additional insulation air barrier between the outdoor ambient temperature and the water temperature. In addition, the wattage heat emitted by the spotlights 24 is recycled by warming the air room cavity 14. Thus, a double thermic insulation barrier system comprised of an air thermic barrier backed with a foam thermic barrier is provided. The air room cavity 14 also act as a sound insulator, decreasing the noise of the jet pump motors located in the local compartment.

### The Internal Structural Wall 16

The internal structural wall 16 separates the air room cavity 14 from the insulation foam 18 and also provides improved rigidity and structure to the roto-molded tub. The internal structural wall 16 can be backed with an optional reflective film for optimal light reflection. The quantity of resin 30 poured in the mold has a direct impact on the thickness of the internal structural wall 16. It will be observed that, in this embodiment, the internal structural wall 16 comprises both a first wall portion 16.1 facing the external cabinet wall 12 and a second wall portion 16.2 backed by the insulation foam. The two wall portions 16.1, 16.2 are separated by an empty area 40 which is defined by the upward extending forks of the bottom side mold 26.

### The Insulation Foam 18

The insulation foam 18, usually made of polyurethane foam but other insulating materials can be used, provides improved energy efficiency, and may be required to meet local compliances and standards such as the California Energy Commission (CEC). Embodiments of the present invention provide a backlit cabinet design 10 while not sacrificing the hot tub insulation.

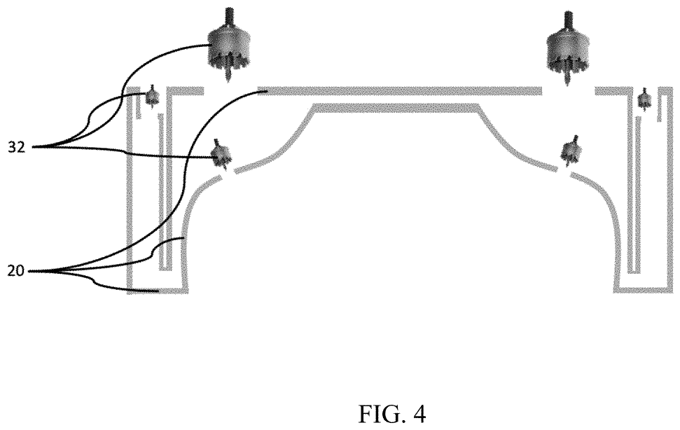

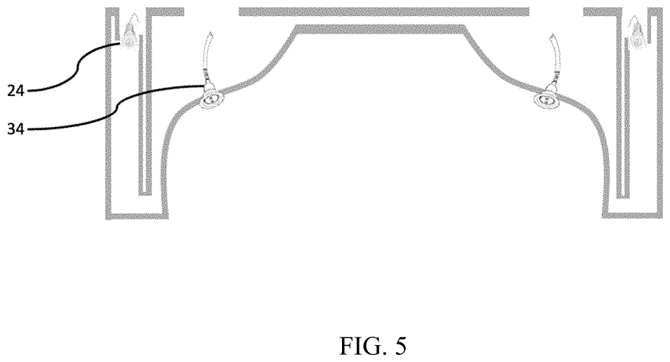

Once the roto-molded process as shown in FIG. 2 is complete, the shell 20 is unmolded as shown in FIG. 3, then cut in different areas as shown in FIG. 4 by means of a hole saw 32 or other cutting tools. The number and location of the cuts may vary according to the hot tub size and the accessibility needs to install the jets 34 and plumbing as shown in FIG. 5.

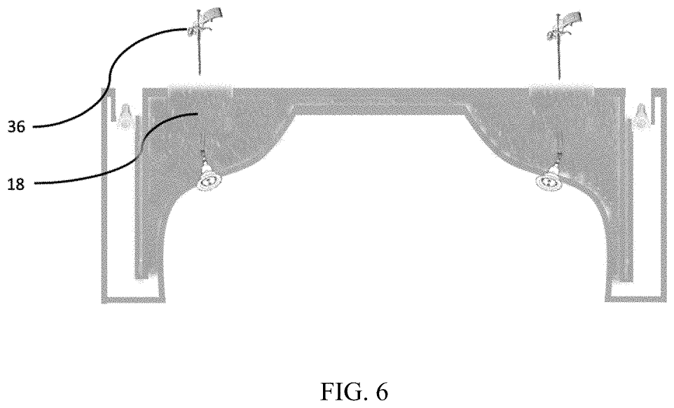

Once the jets have been installed, the shell 20 can be insulated with insulation foam 18 using a foam gun 36 or other compressing tools as shown in FIG. 6. Various insulating materials can be used but polyurethane foam is the insulating material most often used in the hot tub industry. The density of polyurethane foam can vary to obtain a better heat retention and a stronger shell rigidity. The insulation foam 18 acts as an additional thermic insulation barrier that retains the heat of the water 38 on top of the air thermic barrier created by the air room cavity 14.

### The Shell 20

The shell 20 is molded together with the external cabinet wall 12 and the internal structural wall 16. Various colors of resin 30 can be used as long as the resin 30 is translucent enough to let light shine through the external cabinet wall 12 when the shell 20 and the external cabinet wall 12 are made of the same resin, such as in the present embodiment. A white translucent resin color may be preferred if the spotlights 24 are multicolored, since the external cabinet wall 12 will change color with the multicolor spotlights 24. The shell 20 is ideally thick enough (depending on the quantity of resin) for structural integrity and sufficiently colored such that the insulation foam 18 and the jets 34 and plumbing are not visible through the water 38. Nevertheless, the shell 20 should also be sufficiently translucent such that the light of the spotlights 24 provided in the air room cavity 14 can shine through the external cabinet wall 12.

As shown in FIG. 4, the unmolded product, and notably the shell 20, needs to be cut in different locations with the help of a hole saw 32 or other drilling and cutting tools in order to install and glue the jets 34 and plumbing, to seal the spotlights 24 in the recessed bottom perimeter channel 22, and to spray the insulation foam 18. The design of the shell 20 depends on the form of the two-piece mold. Clean straight lines give a more modern and innovative appearance in comparison with the existing roto-molded hot tubs with curved seats and curved bar tops.

### The Recessed Bottom Perimeter Channel 22

As previously mentioned, the recessed bottom perimeter channel 22 is also made of resin 30 and is roto-molded together with the shell 20, with the cabinet and with the internal structural wall 16. The recessed bottom perimeter channel 22 is wide enough to integrate the spotlights 24 as shown in FIG. 5 and deep enough to allow the installation of electric wires, and so forth around the hot tub. The depth of the recessed bottom perimeter channel 22 also prevents the spotlights 24 from being in contact with wet floors. It is possible to fill with foam the empty area 40 remaining between the two wall portions 16.1, 16.2 of the internal structural wall 16 as shown in FIG. 3 left by the removal of the bottom side mold 26. The recessed bottom perimeter channel 22 is drilled with a hole saw 32 as shown in FIG. 4 to install the spotlights 24. Hence, the spotlight 24 is fixed to the recessed bottom perimeter channel with its light emitting portion inside the air cavity 14. This enables installing the spotlights 24 in the air cavity 14. The recessed bottom perimeter channel 22 permits to backlight the cabinet with no use of spare backlit elements attached to the cabinet.

### The Spotlights 24

The spotlights 24 are sealed in the recessed bottom perimeter channel 22 that surrounds the four sides of the roto-molded hot tub. The number of spotlights 24 used depends on the size of the hot tub and on the intended luminosity of the external cabinet wall 12. The luminescence and wattage of the spotlights 24 also has a direct impact on the brightness of the external cabinet wall 12. The spotlights 24 are wired to a controller located in the local compartment and powered by the hot tub control board. A remote control provided with the controller allows the spotlights 24 to be adjusted remotely by a user. Users can thus change the color (if provided) and the brightness of the hot tub as desired. Ideally, users can also adjust the lights on the control panel and for example program automatic light activation and color sequences. Wireless connected spotlights and/or the controller can also be used for remote operations from any connected device. Additional spotlights 24 can be incorporated in the accessory steps (not shown) and connected to the controller. The accessory steps hide the door of the local compartment.

### The Bottom Side Mold 26

The bottom side mold 26 is one part of the two-piece mold used to roto-mold a hot tub according to one embodiment of the present invention. The bottom side mold 26 is attached to the top side mold 28 and resin 30 is poured into the bottom side mold 26 as shown in FIG. 2 before rotating. The bottom side mold 26 shapes the recessed bottom perimeter channel 22, the internal structural wall 16, and the bottom part of the shell 20. Once the roto-molding process is over, the bottom side mold 26 needs to be removed. The design, shape and size of the bottom side mold 26 can vary based on the size and shape intended for the recessed bottom perimeter channel 22, the internal structural wall 16, and the bottom part of the shell 20.

### The Top Side Mold 28

The top side mold 28 is the complementary part of the two-piece mold used to roto-mold a hot tub according to one embodiment of the present invention. The top side mold 28 is attached to the bottom side mold 26 and resin 30 is poured in the bottom side mold 26 before rotating. The top side mold 28 shapes the external cabinet wall 12 and the top part of the shell 20. Together, the top side mold 28 and the bottom side mold 26 shape the air room cavity 14.

### The Resin 30

The resin 30 is the main material of the shell 20, the external cabinet wall 12, the internal structural wall 16, and the recessed bottom perimeter channel 22. As previously mentioned; various colors of resin 30 can be used as long as the resin 30 is translucent enough to let the light shine through the external cabinet wall 12. Recycled polyethylene coupled with the double thermic insulation barrier system can be used to create an eco-friendly hot tub, which may be appealing for some customers and markets.

A reduced quantity of resin 30 in the area of the air room cavity 14 narrows the thickness of the external cabinet wall 12 and improves its exterior brightness. A greater quantity of resin 30 in the center of mold increases the thickness of the top and bottom part of the shell 20 and increases the thickness of the internal structural wall 16 for a stronger hot tub structure. A whiter and more opaque resin 30 can be used in the center of the mold. And a more translucent resin 30 can be used in the area of the air room cavity 14.

### The Hole Saw, the Lets and Plumbing, the Foam Gun and the Water

The hole saw 32, the jets 34 and plumbing, the foam gun 36 and the water 38 as shown in the figures are merely for illustration. Different tools and manufacturing techniques can be used to manufacture the present invention.

### Second Embodiment

FIG. 12 now shows a second embodiment of the present invention. This second embodiment differs from the first embodiment by the fact that it comprises one or more spare backlit elements 12bis, which are attached to the hot tub structure 42. The hot tub structure 42 comprises the shell 20 and the second wall portion 16.2 of the cabinet structure. The hot tub structure 42 can for example be roto-molded using a conventional mold. A spare backlit element 12bis comprises the external cabinet wall 12, the first wall portion 16.1 defining the air cavity 14, and the recessed bottom perimeter channel 22. The backlit element 12bis is fixed to the hot tub structure 42 in any suitable way. FIG. 12 shows a gap between the backlit element 12bis and the second wall portion 16.2, but, in other embodiments, the first wall portion 16.1 and the second wall portion 16.2, may be in close contact with one another.

This embodiment provides the following advantages: It enables to easily provide the backlighting functionality to hot tubs manufactured using existing molds and facilities. In addition, more freedom is allowed in the design of the spare backlit elements 12bis, which do not have to follow the geometry of the bath tub mold. This also enables to use different resins, and hence different structural and optical properties for the hot tub structure 42 on the one hand and for the spare elements 12bis on the other hand.

Though it may be considered easier to simply incorporate spare backlit elements to the cabinet, one of the advantage of building the external cabinet wall in a single backlit piece with the rest of the hot tubs remains on the savings made on spare backlit elements and the labor costs caused to attach them around the cabinet. Both manufacturing solutions work good and will create a backlit cabinet design 10.

1. A double-walled backlit cabinet structure of a hot tub or bath tub, comprising
an external cabinet wall,
an internal structural wall, and
an air room cavity arranged between the external cabinet wall and the internal structural wall,
a shell for receiving water, and
lights installed in the air room cavity to backlight the external cabinet wall.

2. The backlit cabinet structure according to claim 1, wherein a recessed bottom perimeter channel extends around the bottom of the cabinet structure and allows the installation of lights.

3. The backlit cabinet structure according to claim 1, wherein insulation foam (18) backs the internal structural wall, which separates the foam from the air room cavity.

4. The backlit cabinet structure according to claim 1, wherein part of the internal structural wall is part of a hot tub structure, wherein the backlit cabinet structure further comprises a spare element fixed to the hot tub structure, the spare element comprising the external cabinet wall and the air room cavity.

5. The backlit cabinet structure according to claim 4, wherein the external cabinet wall and the internal structural wall are molded together with the shell.

6. The backlit cabinet structure according to claim 5, wherein the insulation foam and the lights vacuum seal the air room cavity to create an insulation air barrier between the outdoor ambient temperature and the water temperature.

7. The backlit cabinet structure according to claim 1, wherein the internal structural wall is backed by a reflective film to reflect light from the lights arranged in the air room cavity.

8. The backlit cabinet structure according to claim 1, wherein the external cabinet wall is comprised of resin, the resin being sufficiently translucent to let light shine through the external cabinet wall.

9. The backlit cabinet structure according to claim 1, wherein the area between the internal structural wall and the shell is filled with foam.

10. A two-piece mold for creating a double-walled cabinet structure according to claim 4, the two-piece mold comprising:
a bottom side mold to shape the internal structural wall, the bottom side of the shell, and the recessed bottom perimeter channel, and
a top side mold to shape the external cabinet wall and the top part of the shell, which receives the water.

11. A method of fabricating a double-walled cabinet structure, of the type used for a hot tub or bath tub, comprising the steps of:
providing a two-piece mold according to claim 10,
attaching the top side mold to the bottom side mold,
pouring resin into the top side mold, and
molding, by a rotational molding process, the double-walled cabinet structure.

12. The method according to claim 11, further comprising the steps of:
demolding the cabinet structure,
cutting the structure as needed,
installing jets and lights, and
insulating the interior of the shell with insulation foam.

13. The method according to claim 12, further comprising the step of applying a reflective film on the internal structural wall.
